(19) United States
(12) Patent Application Publication
(10) Pub. No.: US 2025/0363881 A1
(43) Pub. Date: Nov. 27, 2025

(54) DEVICE FOR PREDICTION AND DETECTION OF FALLS

(71) Applicant: UNIVERSITY OF NORTH TEXAS, Dallas, TX (US)

(72) Inventors: Saraju P. MOHANTY, Dallas, TX (US); Elias KOUGIANOS, Dallas, TX (US); Laavanya RACHAKONDA, Dallas, TX (US)

(21) Appl. No.: 19/217,931

(22) Filed: May 23, 2025

Related U.S. Application Data
(60) Provisional application No. 63/651,280, filed on May 23, 2024.

(51) Int. Cl. G08B 21/04; G08B 31/00

(52) U.S. Cl. CPC G08B 21/0492; G08B 21/043; G08B 21/0446; G08B 21/0453; G08B 21/0476; G08B 31/00

(57) ABSTRACT

A system for detecting falls includes at least one accessory monitoring device that can include one or more physiological sensor configured to sense physiological data from a user and an accelerometer and/or gyroscope. The system also includes one or more cameras and a processor configured to receive data from the one or more physiological sensor, the accelerometer and/or gyroscope, and the one or more camera, analyze the data, and determine a fall status of the user.

### CROSS-REFERENCE TO RELATED APPLICATIONS

This application claims the benefit of U.S. Provisional Application No. 63/651,280, filed on May 23, 2024, and entitled “DEVICE FOR PREDICTION AND DETECTION OF FALLS”, which is incorporated herein by reference in its entirety for all purposes.

### STATEMENT REGARDING FEDERALLY FUNDED RESEARCH OR DEVELOPMENT

None.

### BACKGROUND

Falls are a leading cause of fatal and non-fatal injuries for the aging population. Around a third of elderly people 65 years or older fall each year, and a half of those who do fall tend to fall more than once. As age increases, tendency to fall as well as the injuries one might sustain from falling likewise increases. In the United States, fall-related emergency visits are estimated to be around 3 million per year.

Seniors' safety, privacy, independence, economic, and personal costs are few other factors that are affected since the fall victim requires continuous 24×7 assistance. Over 800,000 hospital admissions, 2.8 million injuries, and 27,000 deaths have occurred in the past few years because of falls. Healthcare expenditures were approximately $48 million in Alaska out of which $22 million were due to falls of older people. The risk of hospital admissions has been reduced up to 34% with the constant assistance provided to the elderly.

### SUMMARY

In some embodiments, a system for detecting falls comprises at least one accessory monitoring device comprising: one or more physiological sensor configured to sense physiological data from a user; and an accelerometer and/or gyroscope. The system also comprises one or more cameras, and a processor configured to: receive data from the one or more physiological sensor, the accelerometer and/or gyroscope, and the one or more camera, analyze the data, and determine a fall status of the user.

In some embodiments, a wearable fall detection device comprises: one or more physiological sensor configured to sense physiological data from a user, an accelerometer and/or gyroscope, one or more camera, and a processor configured to receive data from the one or more physiological sensor, the accelerometer and/or gyroscope, and the one or more camera, analyze the data, and determine user fall status.

These and other features will be more clearly understood from the following detailed description taken in conjunction with the accompanying drawings and claims.

### BRIEF DESCRIPTION OF THE DRAWINGS

FIG. 1 schematically illustrates an accessory monitoring device on a user according to some embodiments.

FIG. 2 schematically illustrates an accessory monitoring device within a monitoring system according to some embodiments.

FIG. 3 schematically illustrates a processing architecture for a monitoring system according to some embodiments.

FIG. 4 schematically illustrates another processing architecture for a monitoring system according to some embodiments.

FIG. 5 schematically illustrates a machine learning model architecture used in a monitoring system according to some embodiments.

FIG. 6 schematically illustrates a system architecture for a monitoring system according to some embodiments.

FIG. 7 schematically illustrates a monitoring process for a monitoring system according to some embodiments.

FIG. 8 schematically illustrates another monitoring process for a monitoring system according to some embodiments.

FIG. 9 schematically illustrates still another monitoring process for a monitoring system according to some embodiments.

FIG. 10 shows the components of an accessory monitoring device according to some embodiments.

FIG. 11 shows an exemplary sensor output over time according to some embodiments.

FIGS. 12A and 12B illustrate exemplary time series outputs from sensors used in a monitoring system according to some embodiments.

FIG. 13 schematically illustrates a monitoring process for a monitoring system according to some embodiments.

FIG. 14 schematically illustrates another monitoring process for a monitoring system according to some embodiments.

FIG. 15 schematically illustrates still another monitoring process for a monitoring system according to some embodiments.

FIG. 16 schematically illustrates yet another monitoring process for a monitoring system according to some embodiments.

FIG. 17 schematically illustrates still another monitoring process for a monitoring system according to some embodiments.

FIG. 18 schematically illustrates a monitoring process for predicting and detecting falls according to some embodiments.

FIG. 19 shows the results of a system for monitoring falls as tested.

FIG. 20 is a schematic illustration of a computer system that can be used to implement various systems and methods according to some embodiments.

For a detailed description of the aspects of the presently disclosed subject matter, reference will now be made to the accompanying drawings.

### DETAILED DESCRIPTION

With improvements in science and technology in the past decade, the ability to provide more advanced 24×7 protection to people at risk of falling such as elderly people is very important. This can be done by taking advantage of the Internet and its connecting ability to remote devices, which is known as the Internet of Things (IoT). The IoT is defined as the network of devices that can be identified with unique IP addresses.

Disclosed herein are embodiments related to IoT enabled edge device(s) configured for detection and/or prediction of fall related accidents. The disclosed embodiments may provide constant or near constant monitoring or care using an accessory monitoring system (e.g., a wearable device, support device such as a cane, etc.) that is useful for users of any age. The embodiments can also provide medical support for one or more occurrences irrespective of the location of any incidents. Also disclosed herein is a method for promoting precautions to help prevent falls, which can be more useful than addressing a fall once one has occurred.

Automatic fall detection has been a point of interest for decades. Multiple different implementations of an automatic fall detection sensor have been attempted, but these efforts typically either have been restrictive in nature due to limited range, or have low sample sizes or unsatisfactory success rates. For example, sole use of accelerometer sensors along with other physiological sensor data may be proposed. The use of accelerometers with an RF signal to capture location may be proposed and the angular velocity of 2D information may be used to detect falls. Such approaches, however, may limit the scope of fall detection accuracy, as no other physiological and vision parameters are considered. The scope of fall detection using barometric pressure sensors in floors may also be proposed. However, this also may not be an ideal solution, as the location of the user is compromised.

The use of vision by using depth camera images with tangential position changes alone may be used for fall detection. However, this approach may not be accurate enough as positions of the fall vary. A camera-based solution for fall detection may be proposed. However, this approach may affect the mobility of the user as it is location constrained. Furthermore, none of the solutions that use sensors or a camera predict the fall before the actual event of fall.

Multiple industries have tried to make commercial products that involve automatic fall detection. However, according to commercial reviewers, these devices fail to accurately predict fall detection and often trigger false alarms. These false alarms are so common that even running may trigger automatic fall detection. Also, none of the products provide prediction of fall before the actual event of fall. Other devices could include a smart watch. However, a smart watch only uses accelerometers and does not work on low threshold materials such as carpet. In the event of a fall, a user would have to select an emergency indicator system, which is not practical if the user is unconscious.

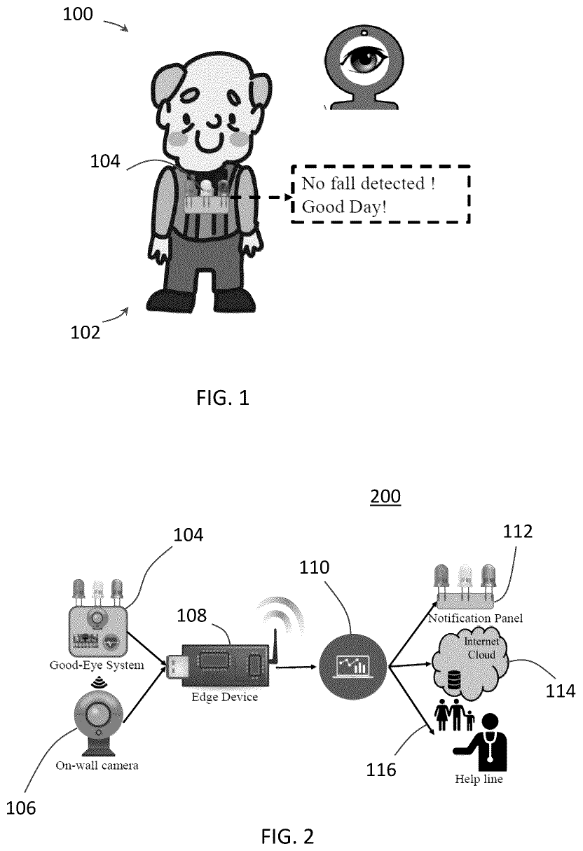

In some aspects, a fall detection device as disclosed herein can comprise an accessory monitoring device such as a wearable device comprising one or more sensors, a camera, a processing device, and an indicator display. Conceptually, the sensor data can be collected by the accessory monitoring device, along with a separate camera, and the user may be notified about one or more fall condition through a display or other output device, such as an LED. An exemplary system 100 is shown in FIG. 1. As shown, a user 102 can wear the accessory monitoring device 104 that can include the sensor(s), and a camera can also be used to observe the user.

Various problems or shortcomings may exist in the state of the art, at least some of which may be remedied, mitigated, or otherwise addressed by the disclosed systems and methods. At least some of these problems or shortcomings may be addressed by the disclosed systems and methods. For example, the systems and methods can provide a system that not only detects the fall but also predicts the fall. The system can provide an improved method of fall detection that does not involve only accelerometers, but also provides vision information with a use of camera in the system. The system that has both an accessory monitoring device associated with the body of the user (e.g., an on-body or a wearable device) and an off-body device such as the camera can obtain much higher accuracy. The system can also incorporate the use of other physiological sensors to provide physiological data as there is typically a change in the physiology prior to a user experiencing an accident. The system also allows information about the environment to be captured before and during the fall to accurately analyze the nature of the fall.

The systems and methods disclosed herein not only ensure detection of a user's fall due to the wearable physiological sensors, but also can include fail-safes in the form of sensors such as a heart rate sensor and/or camera in case the accelerometer registers a false positive. Additionally, the specific use of a camera can provide unique data in that it can photograph the user's surroundings should they fall, allowing first responders to more accurately find the location of the fallen person.

Accordingly, disclosed embodiments may be configured to provide continuous or semi-continuous care to users such as elders with minimal human interaction. For example, disclosed embodiments may include a combination of both physiological and computer vision systems which help to provide a warning for the user before the event of fall. Some embodiments may be used not only to accurately detect falls, but also to capture the environment in which a person has fallen and their internal physiology (which may be useful for analyzing the reason behind the fall). This information can then be used to treat a patient that has fallen more quickly and effectively.

FIG. 2 schematically illustrates an exemplary system 200 relating to systems and methods described here. As shown, the system can comprise an accessory monitoring device 104, a separate camera 106, and an edge device 108 in signal communication with the wearable device 104 and the camera 106. The edge device 108 can be in signal communication with a processing device 110, which can communicate with various systems such as an output display 112, one or more systems over the internet or cloud connection 114, and/or one or more communication systems such as a voice or data connection 116 to provide medical or emergency support. Here, one or more physiological parameters obtained from one or more sensors within or associated with the wearable device 104 along with the camera input data from the camera 106 can be taken from the user and the remote wall respectively, and can be analyzed, for example at the edge level processing unit in the edge device 108. In some embodiments, the processed data can be sent to the family and/or emergency providers for help depending on the emergency.

The accessory monitoring device 104 can comprise a plurality of sensors. The sensors can comprise one or more motion sensors (e.g., vibration sensors), accelerometers, motion detection devices, physiological sensors (e.g., a heartrate sensor, blood pressure sensor, skin conductivity sensor, or the like), and/or one or more cameras. When the accessory monitoring device is a wearable device, the wearable device can be retained in place about a central portion of a user by using various retaining mechanisms such as a necklace band, a chest band, a magnet configured to retain the wearable device with clothing (e.g., a back magnet used on an inside of a pocket or shirt to retain the device), or the like. In some aspects, the accessory monitoring device can be associated with a personal item such as a cane, as described in more detail herein. In some aspects, the accessory monitoring device 104 can comprise a power source such as a rechargeable battery to allow the accessory monitoring device to operate.

The edge device 108 can comprise any suitable device that can be used with the accessory monitoring device 104 or separate from the accessory monitoring device 104, but within signal communication of the accessory monitoring device 104. When the edge device 108 is not part of the accessory monitoring device 104, the accessory monitoring device 104 can comprise a processor and memory to allow the sensors to operate and communicate with the edge devices using a communication system (e.g., WiFi, Bluetooth, radiolink, data channel, voice channel, etc.).

Emotions and physiology are connected and correlated. Falls can be considered as one of the stressors in the human body as they elicit a fight-or-flight response. Under stress conditions, active coping strategies and passive coping conditions occur. Hypertension and tachycardia (an increase in the heart rate) as well as hypotension and bradychardia (a decrease in the heart rate) occur under such conditions. A fall can trigger an active coping strategy. Thus, disclosed embodiments may be able to infer that a fall can cause a physiological response. Stress causes the release of epinephrine and has an impact on various physiological parameters depending upon the stressors.

Some of the frequent physiological parameters that vary with age and that are affected by stress can include sweat, heart rate and blood pressure variations, temperature changes, and vision changes. The sweat glands tend to become less effective due to aging skin. This means that older individuals tend to sweat less, which means it might not be a useful factor to consider in fall detection. For example, sweat gland output per active gland can be significantly lower for those aged 58-67 than it was for those aged 22-24 and 33-40. Sweat glands typically have decreased sweat output as one ages. Similarly, cardiac output decreases linearly at a rate of about 1 percent per year in normal subjects past the third decade. As an example, the resting supine diastolic blood pressure for younger men was 66+/−6 and 62+/−8 for older men. Significant change in the mean body temperature is not generally observed in the human body over time (e.g., with age). Under stress, temperature fluctuations can sometimes be observed depending on the area of the body. The temperature may not vary at the chest or stomach while it can vary at the hands and wrist. Aging has a significant effect upon vision. This is due to multiple factors, such as spatial contrast sensitivity loss, reduced eyesight in dark situations, and reduced processing potential in terms of visual information.

Based, for example, on the above factors, disclosed embodiments may be configured in such a way that the behavioral changes in physiological signals can be considered not just to detect falls but also to predict falls. By way of example, embodiments may include an accessory monitoring device (e.g., that could be placed near the chest portion of the user) and an off-site on-wall camera that is connected to the accessory monitoring device through an internet connection. The data collected from the system can be processed at the edge device where the parameter analysis and the decision on prediction or detection is made as shown in FIG. 2. While this data may be sent to the user as feedback to notify the change, it can also be sent to a helpline and/or storage (e.g., cloud based storage or database).

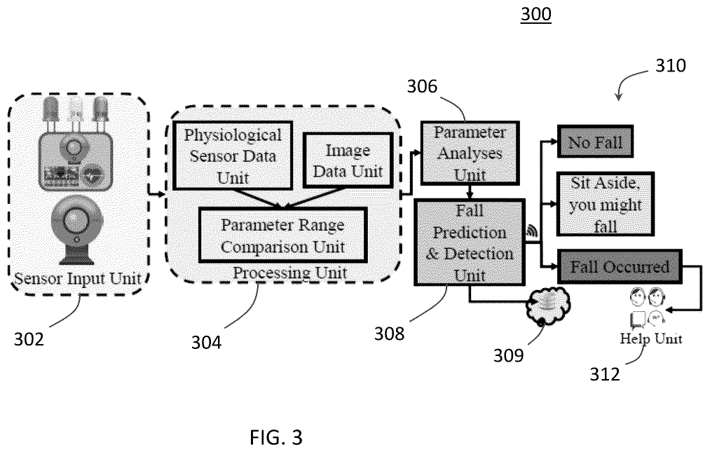

FIG. 3 illustrates an exemplary architecture 300 for an exemplary system, such as the system 200 of FIG. 2. By way of example, the input data 302 can be collected from the one or more sensors (e.g., the accessory monitoring device 104 and/or camera 106 of FIG. 2). The input data 302 can be processed in the processing unit 304, which can comprise a physiological sensor unit and/or an image data unit, which can process the environmental and orientation change data observed in the on-user and off-user cameras. This data can then be compared and analyzed with respect to set threshold ranges, as explained in more detail below. The resulting output can be provided to the user as a notification, for example by a plurality of LED lights (e.g., with each light representing an outcome such as no fall, sit aside—you might fall, or fall has occurred), or a display unit.

The processing unit 304 can receive the sensor data from the accessory monitoring device and off-user camera(s) and analyze the data. In some aspects, the processing unit is part of the edge device. The data can optionally pass through a parameter analysis unit 306 to format and select the data. This data can be sent to the fall prediction and detection unit 308 where the decisions on prediction, detection, and control are taken, respectively. The fall prediction and detection unit 308 can store the results and data in a data storage 309 such as a server. The notification on the level of prediction and detection is represented using the LED lights on the wearable. The outputs 310 from the fall prediction and detection unit 308 can also be displayed or acted upon as described in more detail herein. A help unit 312 can be used to provide an alert to a relative, guardian, or emergency personnel as described in more detail herein. In some aspects, the system can be implemented as an Internet-of-Medical-Things (IoMT) based Healthcare Cyber-Physical System (H-CPS) framework. Each device in the system can have an on-site processor for making decisions of falls, while outdoors, or in case of disconnections.

Most typical fall-detection devices cannot detect whether a human is wearing the monitoring device or if it is moved off the user (e.g., being thrown, dropped, etc.). Additionally, accelerometers can have false alarms due to things like falling into a bed, moving down stairs, and the like. The disclosed systems and methods have been configured with additional parameters, which, for example, may be able to detect whether a human is actually using the fall detection device and/or to provide multiple instances of confirmation in order to make the system less prone to false positive results.

The system may also make it possible to send important data to first responders so that a human can verify whether a fall has occurred, such as average heart rate or images of the person's surroundings in the moments before and after they fell. By way of example, factors which may be considered in fall predicting and detecting approaches can include change in the axes of the accelerometer, sudden change in the heart rate variability of a person compared to the resting heart rate, having an on-user camera in the accessory monitoring device to measure the change in orientation, which may analyze the intensity of a fall and provide certain care as per the emergency, and/or having an off-user wall mounted camera in the surrounding space of a person, which may enable continuous person detection and tracking to provide proper feedback.

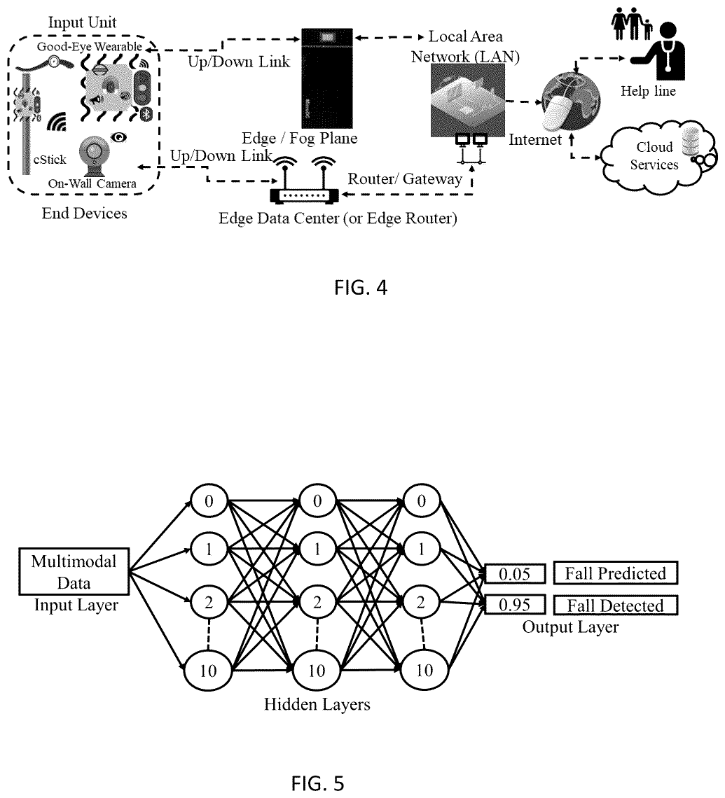

Another system architecture-level representation is shown schematically in FIG. 4. Here, the physiological sensors and corresponding output data along with the camera input data are taken from the user and are analyzed at the edge level processing unit. This processed data can be sent to the family and doctor for help depending on the emergency.

Various models can be used by the edge processing unit to detect and/or predict falls. In some aspects, various threshold based models can be used to detect falls or near falls based on the available data. In some aspects, various machine learning models can be used with the input data to detect a fall that has occurred as well as predict the likelihood of a fall based on the current sensor inputs. A machine learning architecture is shown in FIG. 5 and can be represented in the form of layers and neurons that have been used for the process of fall analyses. In some aspects a tiny DNN model can be used in the system. A fully Connected Neural Network (FCNN) model with a linear stack of 1 input layer, 3 hidden layers, and 1 output layer with 10 neurons each can be used as an example. The data training methodology can include the following:
1. Set the epoch value. Iterate each stress epoch. This epoch defines the number of times the dataset to loop.
2. Inside every repetition, iterate every example from training dataset by correlating its input features, i.e., the physiological parameters and the output labels, i.e., the stress levels.
3. Using these features and training dataset, make inferences.
4. Compare the actual stress level outputs with the stress predictions from the previous step.
5. Calculate loss at every epoch.
6. Calculate the training data loss and accuracy in order to determine the overall efficiency.
7. Update the variables to predict stress levels with the help of optimized algorithm using the Gradient Descent algorithm.
8. Repeat the above steps for all the stress epoch count.

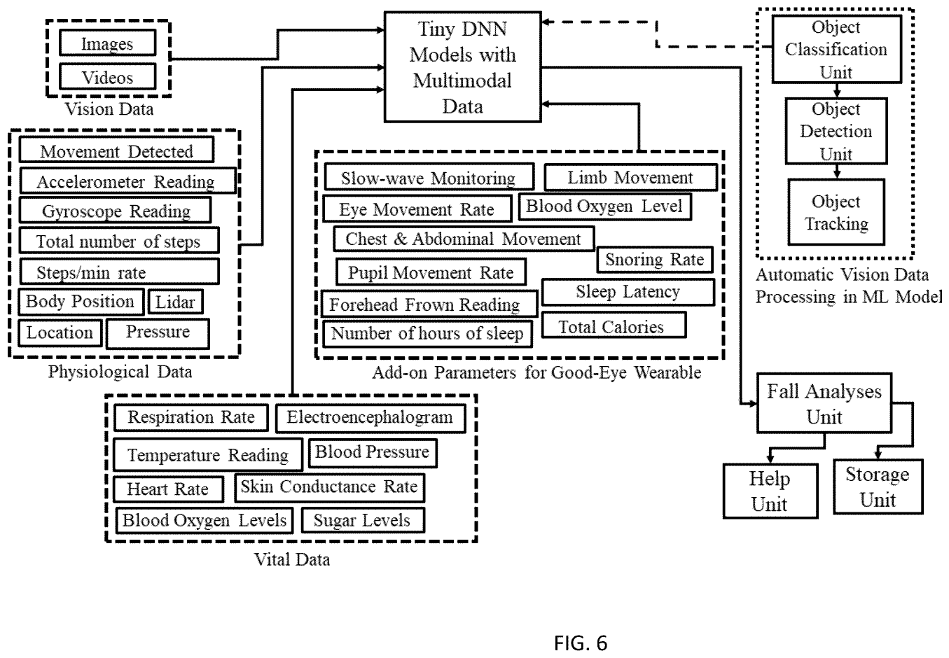

A more detailed block level representation of the system is shown in FIG. 6. As shown, various types of data from the different devices can be obtained and used in the system, where the data can be obtained from corresponding sensors. For example, the vision data can be obtained as still frames and/or video with varying frame rates, and can include images and/or videos. The physiological data can be obtained by one or more sensors and can include, but is not limited to, movement data, accelerometer readings, gyroscope data, step counter data, body position sensor(s), lidar reading, location data (e.g., GPS, WiFi location data, etc.), pressure readings, temperature readings, time data, and the like. Vital data can also be obtained from one or more sensors and can include respiration rate, electroencephalogram data, body temperature readings, blood pressure readings, heart rate data, skin conductance data, blood oxygen levels, sugar levels, blood alcohol levels, and the like. Additional data can also be used such as slow-wave monitoring, limb movement, eye movement data, chest and abdominal movement (e.g., breathing rate, heart rate, etc.), pupil movement rate, snoring rate, forehead frown data, sleep latency and sleep data, number of hours of sleep, calorie data, and the like. The data from the different devices can be collected and sent to the fall analyses unit. The design flow of an exemplary system as a whole may comprise an additional off-user camera, with exemplary flow of the system further illustrated below. For example, some system embodiments may include an on-user portion and/or an off-user portion. The off-user camera or vision data can be used with the system and can include a processing unit to perform object classification, object detection, and object tracking in the images. For example, various convolutional neural networks can be used for image classification and object detection.

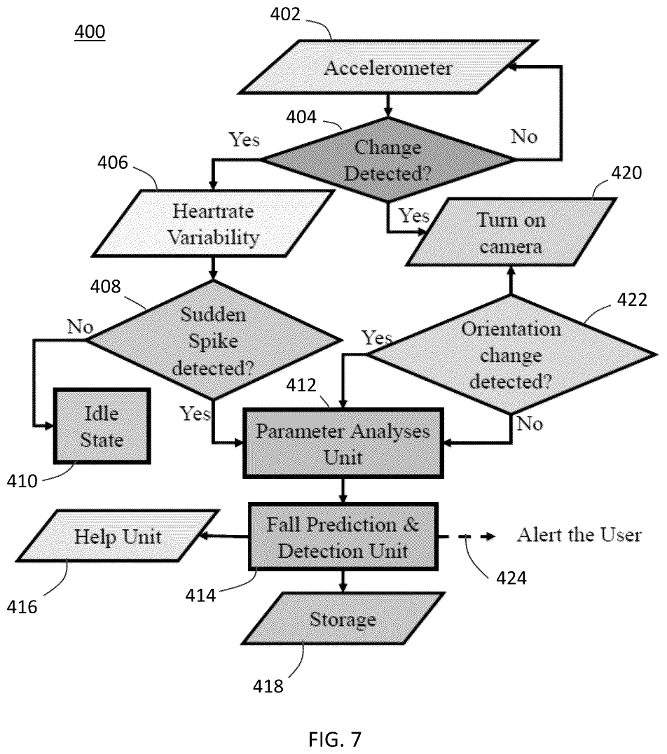

For an on-user design flow 400 of the system, the physiological sensor data along with the environmental capture data can be obtained at the on-user portion of the system. By way of example, the flow of the design can be as shown for example in FIG. 7. Accelerometer sensor changes may be considered as a prime source for the system to start running so as to respect the privacy of the user. Whenever an accelerometer 402 reading change is detected at step 404, the heart rate data can be obtained in step 406 and checked for a sudden spike in heart rate variability in step 408. Along with the heart rate detection, a change in the camera's orientation can also be checked based on the accelerometer data exceeding a threshold. For example, the camera can be turned on at step 420 if the camera is not already on, and an orientation change based on the camera output can be detected at step 422. The moment there is an observed change in the accelerometer, the camera can begin to capture the surroundings of the user.

Even if no change in the camera's orientation is observed at step 422, the data obtained from the camera can be sent to the parameter analysis unit 412 where range comparisons can be performed as explained in in more detail below. This may be done in order to maintain a movement log of the user, for example. When there is no sudden spike detected in heart rate variability at step 408, the sensor can again be taken to an idle state 410. From the parameter analyses unit 412, the decision of fall prediction or detection (e.g., using the fall prediction and detection unit 414) can be performed as explained in more detail below. The decisions are typically sent to family and/or helpline in step 416 based on the level of emergency in addition to storing the various data and outputs in storage 418. The user can also be alerted and/or a status indicator can be updated at 424.

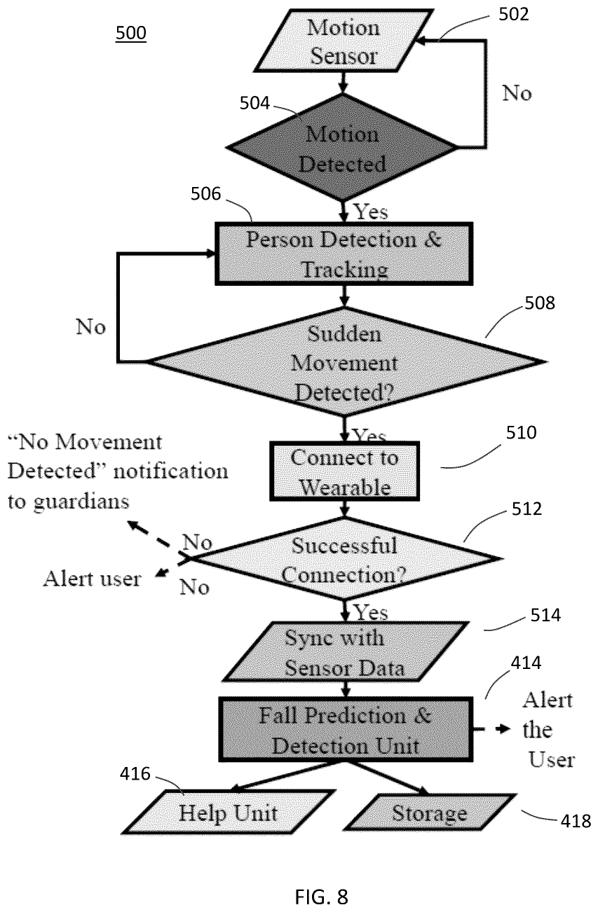

For the off-user design flow 500 of the system, the off-user (e.g., an on-wall) camera can play a role in the system and process for fall detection and prediction in the system with a unique design flow as shown, for example, in FIG. 8. In some aspects, the off-user camera can be useful in the event that the user forgets to have an on-user unit (e.g. the user forgets to wear the wearable portion). The camera can be placed in view of the user such as on a wall, on a shelf, on the ceiling, or any other location that can provide a view of the user in the environment being monitored. In some aspects, the camera may start working the moment motion is detected in the room at step 504, with the camera then continuously detecting and tracking the person at step 506 so as to maintain the privacy of other people in the environment. The camera can be used to serve as the motion sensor 502 and/or a separate motion sensor (e.g., an infrared motion sensor, etc.) can be used to detect motion and then activate the camera. When there is a sudden change in the movement of the user detected using the camera data (e.g., still frames or video, etc.) at step 508, instead of giving a false positive result, the system can connect to the accessory monitoring device at step 510 to collect the physiological sensor data. When the connection is successful at step 512, the physiological data can be synced with the camera data at step 514 and be provided to the fall prediction and detection unit 414. Based on the physiological data and the on-site camera's orientation, the parameter analyses along with the decision of prediction or detection can be made. The decisions are typically sent to family and/or helpline in step 416 based on the level of emergency in addition to storing the various data and outputs in storage 418. The user can also be alerted and/or a status indicator can be updated based on the output.

In the instance that the user is not wearing an on-user wearable or when the off-user camera is not able to obtain the physiological sensor data from the wearable device, a notification such as “No Movement Detected” may be sent to the guardian and/or to the doctors. The system can also alert the user as a reminder to wear the wearable. With this notification, not only can the false positive cases be reduced, but also the incidents of stroke can be quickly addressed instead of waiting for the user to manually ask for help.

In some embodiments, a parameter analysis unit may be configured to analyze one or more parameters (e.g., from parameter data acquisition from the accessory monitoring device and/or off-user camera). To incorporate heart rate variability (e.g., of the wearer/user) into the overall fall detection program, the system can check if there is a sudden spike in heart rate every few milliseconds, as the human body in such accidents typically may experience either a higher heart rate or a lower heart rate. For example, the maximum heart rate in older men may be lower (e.g. at around 162+/−9 beats/min) than the maximum heart rate in younger men (e.g., 191+/−11 beats/min). Therefore, the heart rate variability to the resting heart rate of every individual can be considered as the threshold.

In some embodiments, detection of a fall can depend on a period of weightlessness followed by a large impact, for example an impact that increases the acceleration of the y-axis of an accelerometer by greater than 1.5 g-forces (g's), greater than 2 g's, greater than 2.5 g's, or around 3 g's. In some embodiments, the accelerometer may constantly read the x, y, and z values of the g-force exerted upon a human being (e.g. wearer/user) wearing the device. If the y value of the g-force exceeded ±3 g's, the accelerometer may indicate that the threshold required to detect a fall has been exceeded.

A camera orientation sensor can be implemented using a method that estimates orientation based on sequential Bayesian filtering. This process can identify a location of the user within an image, and therefore a room or location, based on the orientation of the user in the image. For example, the center of the frame may be considered, with x and y axes. The respective r, g, and b values can be calculated and the distances from each frame can be stored for each pixel value. These pixel values may be compared to the threshold in order to decide if the event is indicative of a fall or not. In some embodiments, a picture will be snapped when the accelerometer passes the threshold value, and another picture will be snapped when the accelerometer's values return to a new resting position.

The analysis (e.g., by the fall prediction and detection unit of the system) for the decision of whether an incident is a fall or not a fall can be based on considering the change in accelerometer data, change in heart rate variability, and/or change in orientation of the camera or user within an image. An example is provided in Table 1, illustrating an exemplary analysis process.

The methodology that is involved in the camera of the system is explained herein, for example as follows for two different frames through exemplary Algorithm 1 presented in Table 2. In some embodiments, even if a fall is not seen as occurring but the other two parameters (heart rate and accelerometer) are reached, the camera can send the last few seconds of data to a first responder, helpline, or emergency contact, who can determine whether a fall has truly occurred (e.g., with the camera information allowing a trained human to access whether there has been a fall, for example as a backup to automated detection). This type of approach can make the system more reliable, and may prevent waste of resources (e.g., by preventing the need to send medical help for false alarms).

TABLE 1
Analyses for Fall Prediction & Detection

| Accelerometer | | Camera | |
|---|---|---|---|
| Sensor Data | Heart Rate Variability | Orientation | Decision |
| Change in y | Sudden change in | Change in | Fall Detected |
| value to ±3 g | heart rate detected; | 45% of pixels | |
| | Typically ±10 bpm | | |
| Change in y | No Sudden change in | Change in | No Fall |
| value to ±3 g | heart rate detected; | 45% of pixels | Detected |
| | Typically ±10 bpm | | |
| No Change in y | Sudden change in | Change in | Predicted |
| value to ±3 g | heart rate; | 45% of Fall | |
| | Typically ±10 bpm | | |

TABLE 2
EXEMPLARY ALGORITHM
Algorithm 1 Algorithm used to build Good-Eye Model

| | |
|---|---|
| 1: | Scan a movement of Frame1 at time t₁. |
| 2: | Assign X₁ and Y₁ positional values at the center of the |
| | scanned frame. |
| 3: | Assign garbage values to R₁, G₁, B₁ variables. |
| 4: | Convert the x₁ and Y₁ positional values to R₁, G₁, B₁ values |
| | by setting the variable R₁ to (X₁ + Y₁)/100*256, G₁ to (1 − (X₁ + |
| | Y₁))*256 and B₁ to (1 − (0.5 − (X₁ + Y₁)/100)²)*20 respectively. |
| 5: | Scan a movement of Frame2 at time t₂. |
| 6: | Repeat steps 2, 3 and 4. |
| 7: | Calculate the distance (d₁) between (R₁, G₁, B₁) and (R₂, G₂, B₂) by |
| | using the distance formula, (R₂ − R₁)² + (G₂ − G₁)² + (B₂ − B₁)². |
| 8: | Store the d₁ value for every pixel, counting whichever pixels are |
| | above a set threshold (say, d₁ = 70). |
| 9: | Checks if this threshold is reached for at least 45% of pixels. |
| 10: | If there is a 45% change, a fall has occurred. |
| 11: | Repeat the above steps for all frames. |

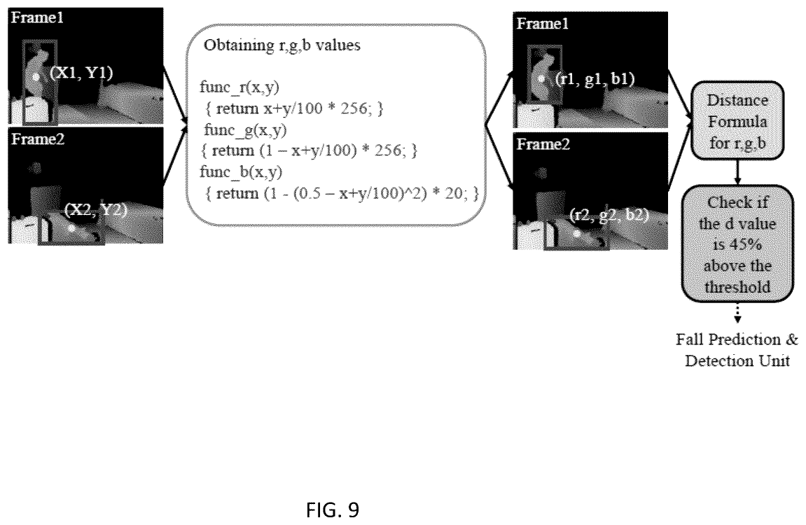

FIG. 9 illustrates an exemplary model represented with depth image data. As shown, two frames representing different views in time can be analyzed. The r, g, b values can be obtained as shown in Table 2, and the values can be used to identify a distance and/or position of the user within the images. When a distance or position has changed, for example, as measured by a change above a threshold percentage of pixels, the system can determine that a fall has occurred.

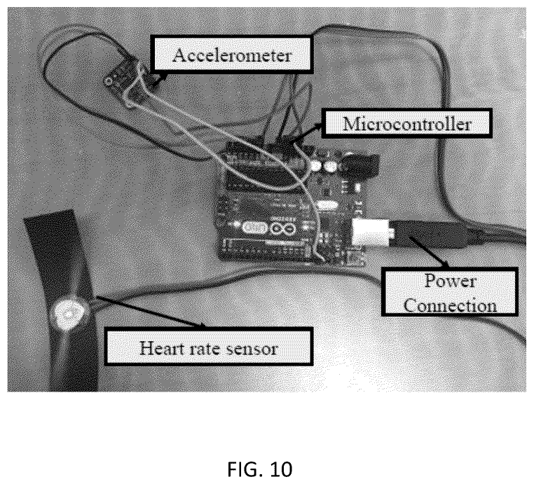

The accessory monitoring device (e.g., the device 104 of FIGS. 1 and 2) can comprise a processor (e.g., as the edge device 108, etc.) and one or more sensors. In some embodiments, the microcontroller where the processing is performed can be connected to an accelerometer (e.g., a tri-axial accelerometer), a heartbeat sensor, a camera, and one or more additional sensors (e.g., temperature sensors, skin conductivity sensors, position sensors such as a GPS sensors). The device can also comprise a power source such as a battery to power the device during use. An exemplary system is shown in FIG. 10.

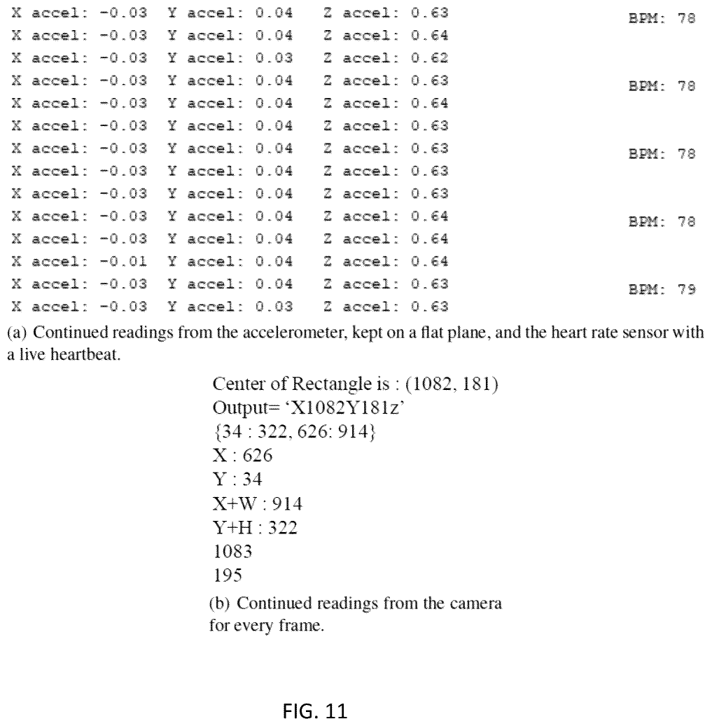

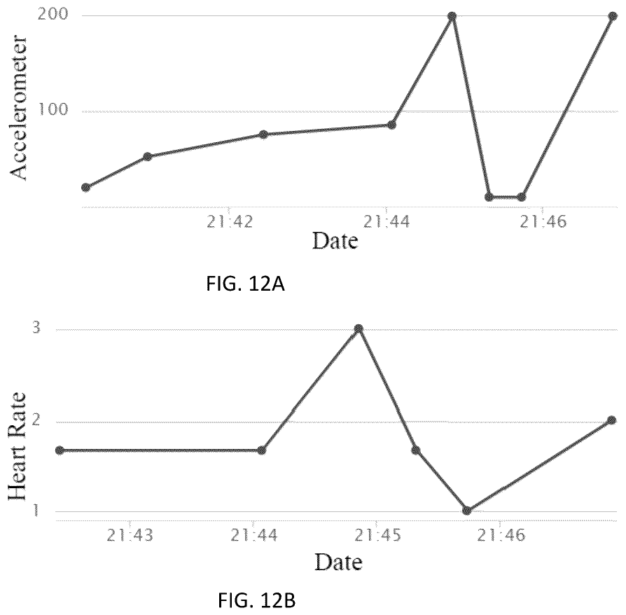

In some aspects, an algorithm for determining and/or predicting a fall may operate by taking both heart rate and accelerometer data simultaneously. The microcontroller may store previously recorded data as a means to compare between image frames. In some aspects, the multiple frames can be recorded at millisecond timescales. For example, the separate data can be recorded between about 10 milliseconds and about 2 milliseconds apart, though longer timeframes such as up to 1, up to about 2, up to about 3, up to about 4, or up to about 5 seconds can also be used. Once the accelerometer's y-axis has a change of more than 2 g's between the measurements, the heart rates of the user can immediately be compared, along with the orientation check from the camera images. If the heart rate of the user has spiked by a threshold amount (e.g., at least about 5 beats per minute (bpm), at least about 10 bpm, etc.), an alarm can be triggered. FIG. 11 illustrates exemplary continued readings from the accelerometer, camera and heart rate of an exemplary system. In some embodiments, the continuous data collected from the system (e.g., as shown in FIGS. 12A and 12B) can be stored in a data storage such as an open source cloud IoT analytics platform. The data stored here can be accessed by the user depending on the requirement.

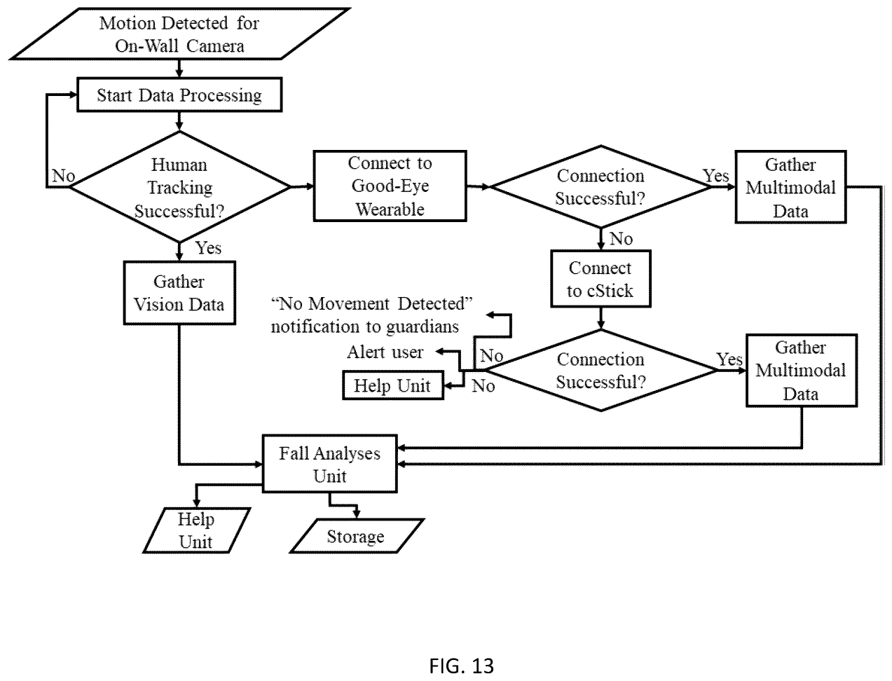

Additional embodiments of a process workflow for an overall system having at least one off-user camera and at least one accessory monitoring device are shown in FIG. 13, which can be performed in the edge device or a larger processing device. The process is represented starting from the off-user camera. If there is a motion detected using the off-user camera or a motion detector, then the data processing is started to automatic human tracking performed along with gathering of the visual data. The processing device then tries to establish a connection with the accessory monitoring device located on or near the user, which can be a wearable device or a personal use device such as a walking stick or cane. If this connection is successful, the complete data collected from this combination is used to analyze falls. If the connection from the off-user camera to either of the accessory monitoring devices fails, the gathered data is still sent to the fall prediction and detection unit for the safety of the user.

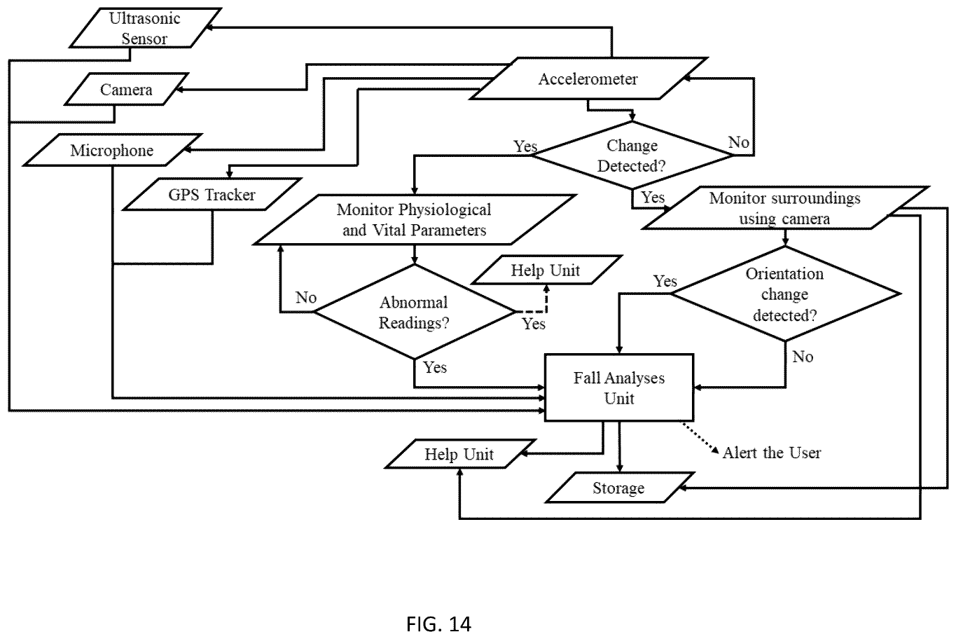

The working principle of the accessory monitoring devices as a wearable device is shown schematically in FIG. 14. As shown, the monitoring process can start with monitoring the accelerometer to determine if a change is detected. If a change is not detected, then the process can return to wait for an input from the accelerometer in the device. When a change is detected, the system can initiate monitoring from an ultrasonic sensor, the camera, a microphone in the environment, and a position sensor such as a GPS sensor. The system can then both monitor the surroundings using a camera in the accessory monitoring devices as well as monitoring physiological and vital parameters. The physiological and vital parameters can be used with a threshold or machine learning model (e.g., a tiny DNN model, CNN, etc.) to determine if there are any abnormal readings. If the readings are determined to be abnormal, the output of the models and/or physiological and/or vital data can be sent to the fall detection unit. At the same time, the on-user camera data can be used to monitor an orientation or position change of the user. If a position or orientation change is detected, then the determination and data can be sent to the fall detection unit. Using all of the available data, the fall detection unit can then determine if a fall has occurred, as described in more detail herein. When a fall occurs, an alert can be provided to send help for the user. The data can also be stored for use in assessing the fall.

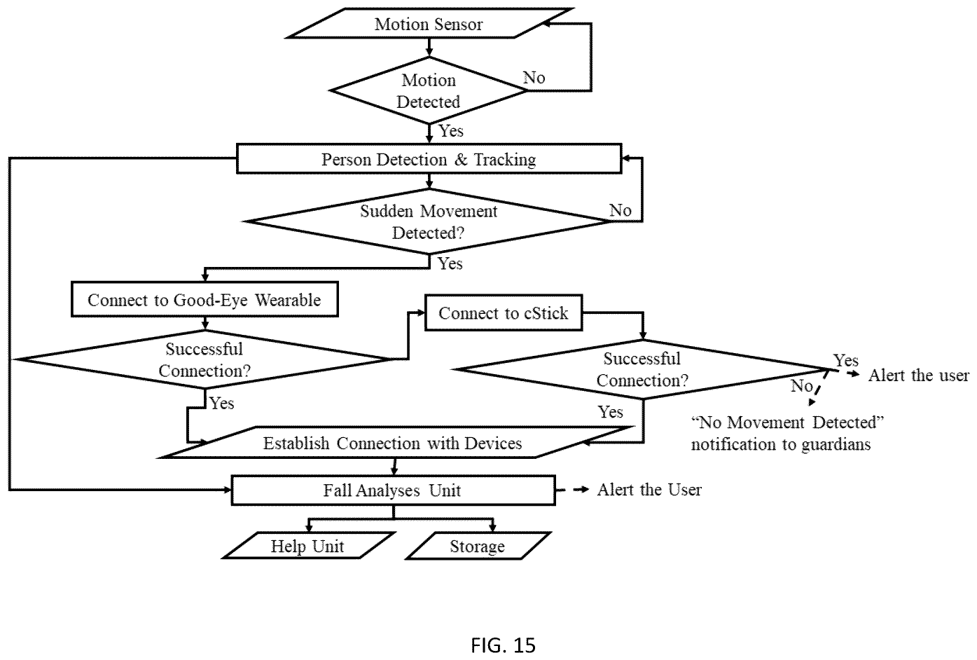

The proposed working principle of the off-user camera is shown in FIG. 15. The off-user camera can be positioned at any suitable location in the environment as described herein, including on a wall or other location capable of viewing the user. As shown in FIG. 15, the operating process can start with detecting motion at the off-user camera. Motion can be detected using the camera itself and/or another motion detector such as an infrared or ultrasonic sensor. If no motion is detected, the process can return to the motion sensor to wait for a detected motion. When motion is detected, the process can initiate the personal tracking and detection of the user in the images. This can include the use of various machine learning models to detect a human in the images and compare between frames of the images to track the movement of the user. The detection and tracking can be used to detect sudden movement in the images. If no sudden movements are detected, then the process can remain in the tracking and detection process. When a sudden movement is detected, then the system can attempt to connect to the accessory monitoring device. Initially, the system can attempt to connect to an on-user (e.g., wearable) version of the accessory monitoring device. If the connection is successful, then the system can attempt to connect to any other available accessory monitoring device such as a personal device. If the connections are successful, then data from the accessory monitoring device(s) can be combined with the output of the image based tracking and detection and sent to the fall analysis unit, which can perform the fall analysis as described herein.

Within any of the processes described herein, including the tracking described in FIG. 15, the automatic process of human tracking and detection can, in some embodiments, be performed according to the following algorithm:
1. Images which are to be used for testing and training the model are collected.
2. The formats of the images are converted from JPEG to XML after creating bounding boxes (e.g., automatically) by using any graphical image annotation tool.
3. Multiple bounding boxes in various images for the same feature, which are called priors, can also be created in the same annotation tool.
4. Using box-coder, the dimensions of priors are made equal.
5. By considering the concept of IOU (Intersection Over Union), the matched and unmatched thresholds for matching the ground truth boxes to priors are set. This is mandatory as the model will not be ready for training if the match hasn't been made.
6. Images in XML format are made equal in size by using either reshape or resize functions.
7. Using convolution and rectified linear functions, the feature maps are assigned to every image sent to the model.
8. Based on these features, the images are either sent to regression or classification where the objects are detected through boxes in the images.
9. Repeat the above steps for all the images.

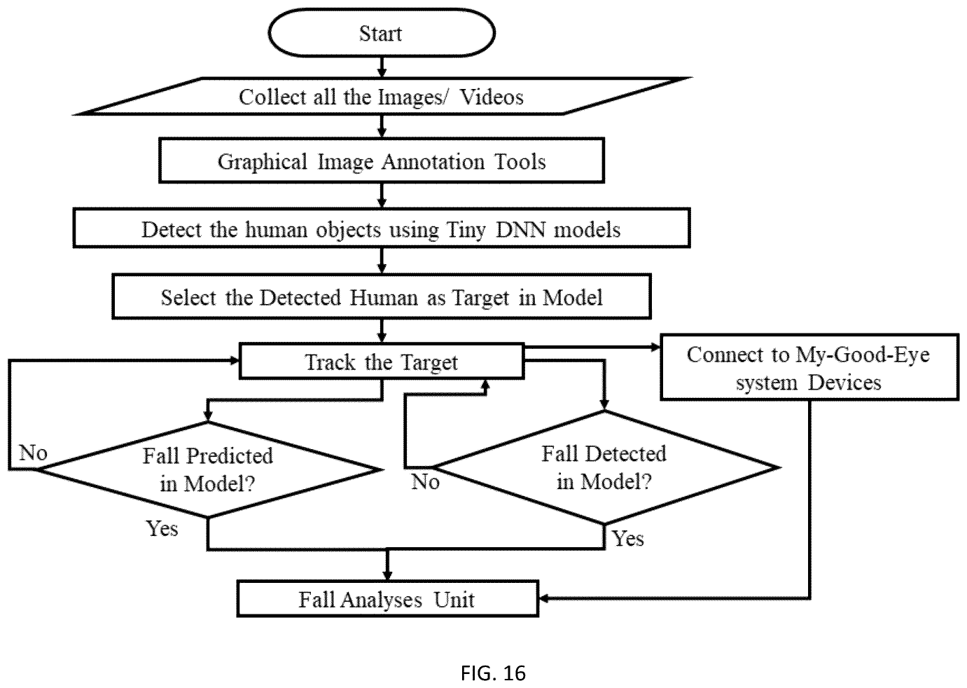

An embodiment of an image tracking process is shown in more detail in FIG. 16. As shown and in relation to the process outlined, the process can begin with the collection of the images. Frames from the images and/or video can be used in the image processing. Initially, the images and/or videos can be collected. The images can be formatted as needed for further processing. A graphical image annotation tool can then be used to identify the shape of a human within the images. The human shaped objects can be detected using a machine learning model such as a tiny DNN model. Once detected, a selected human can be identified as a target in the model. The human can then be tracked between frames and the information (e.g., position, orientation, distances, etc.) can be used with a fall detection model to identify if a fall has occurred. When multiple human shapes are identified in the images, multiple tracking and fall detection routines can be used to monitor each human separately. When no fall is detected, the process can return to the tracking step. When a fall is detected, the information and data can be sent to the fall prediction and detection unit as described herein. In some aspects, a connection with one or more accessory monitoring devices can be established, and data from the accessory monitoring device(s) can be used with the image analysis in the fall analysis unit.

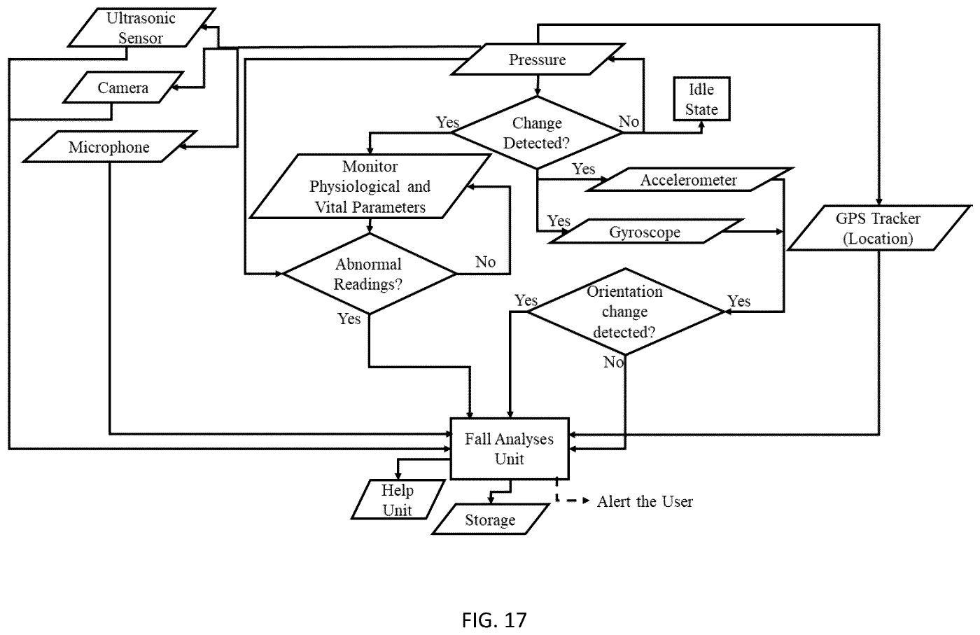

The automatic working principle of an accessory monitoring device comprising a personal use device such as a cane or walking stick is shown in FIG. 17. As shown, the process can begin by monitoring a pressure or force applied to the personal use device. When there is a pressure detected, the camera in the personal use device can begin to operate and the additional sensors such as a lidar can be activated and begin to record the surroundings. The accelerometer and gyroscope in the personal use device can be monitored with importance when compared to the rest of the physiological signal parameters and vital data monitoring, to provide utmost care to the user. If there is an orientation change in the personal use device, then the information can be sent to the fall prediction and detection unit. At the same time, any abnormal readings in the physiological and vital parameters can also trigger the sending of the resulting data to the fall prediction and detection unit. Other sensors can be initiated with the pressure or applied force to the personal use device such as an ultrasonic sensors, a camera in the personal use device, a microphone, and/or a location sensors such as a GPS sensor. The available information can be sent to the fall prediction and detection unit as described herein to determine if a fall has occurred.

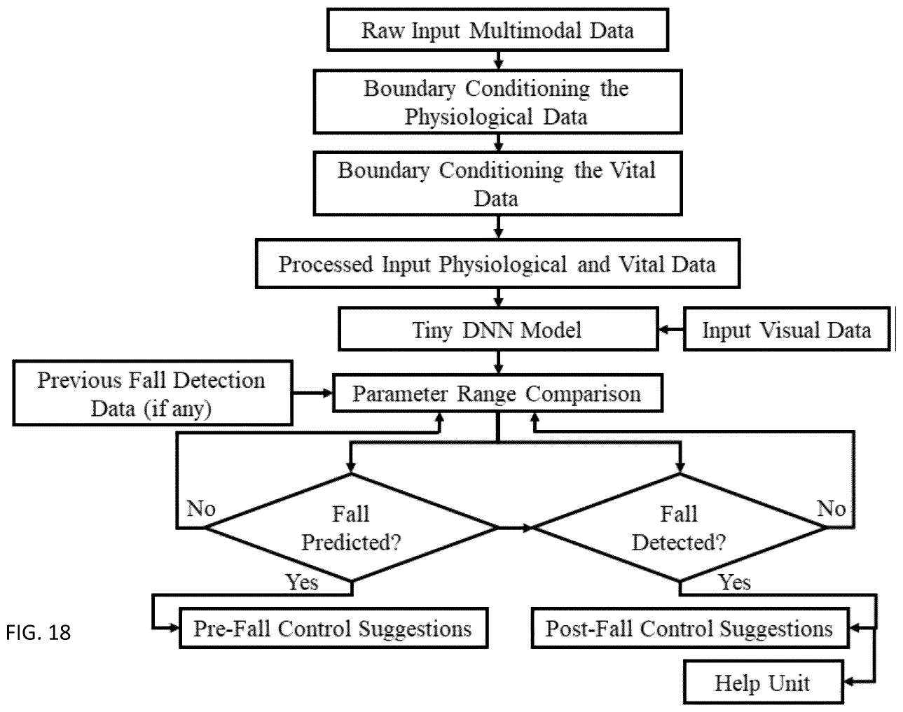

An embodiment of a process for predicting and detecting falls is shown in FIG. 18. The fall prediction and detection process can be used in any of the fall analysis units and/or fall prediction and detection units described herein. The fall analyses unit can have both fall prediction and detection units to navigate the process accordingly. Initially, the raw unprocessed data can be received as described herein and then processed and fed into fall prediction and detection models. The raw data can initially be processed using boundary conditioning for the physiological data and boundary conditioning for the vital data. This can produce a processed input data set for the physiological data and the vital data.

In some aspects, the fall prediction and/or fall detection model(s) can comprise tiny DNN model(s) that can be used along with the visual data. The model(s) can be used with the processed input data set along with any available visual data (including raw or processed visual data) to analyze the events of falls or fall occurrences. In some aspects, previous fall detection data can also be used as the basis for training or comparison for the ranges. The data can be taken and compared to the baseline parameters in the process called parameter range comparison. From here, the data can be processed to determine if there is a fall predicted. If a fall is predicted, then the user is alerted with some pre-fall control suggestions to not have the fall. Some of the pre-fall control suggestions based on physiological, vital, and vision data can include, but are not limited to, alerting the user to slow down, alerting the user to take deep breaths, alerting the user to eat or take medication, or the like.

From here, the data is also sent to a fall detection model to determine if there is an actual fall occurrence, and the user can be provided with post-fall suggestions to reduce the impact of the fall. Some of the post-fall control suggestions based on physiological, vital, and/or vision data can include, but are not limited to: asking the user not to move or strain any part of the body, alerting the user that the help is on the way, and/or enabling two-way communication so the user can express real-time situations. In the case of an unconscious fall, the user need not press SOS or the panic button as the notification is sent to the help unit based on the fluctuations of multimodal data. For example, the help unit can be used to determine if a fall has occurred, but there is no further movement or input from the user to send an alert.

The control mechanisms for fall predictions and detections are mainly concerned with the factors that caused the fall. In terms of non-traditional falls, e.g., the falls that are not caused due to tripping or slipping, any other reasons which may include low respiration rate, low blood oxygen levels, slow wave frequencies, and low or high blood sugar levels. Having analyzed such factors will help to analyze the fall if there is any or will help to understand the health of the user.

In the case of visually- or hearing-impaired older adults, vibration modules, speakers, and lights can be presented so the user can be alerted to prevent the fall, and automated care is provided to the user alongside informing the help unit, in case of an accident.

In conclusion, a way to reliably detect falls is of utmost importance for the health of elderly people. The exemplary device and/or system embodiments disclosed herein not only use an accelerometer, but also other physiological sensor data that enhance the usage of a fall detection device and make it more accurate. The camera inputs and physiological sensor data inputs can be independently significant in relaying data and verifying that the device is accurately predicting and detecting the event of fall. Thus, disclosed device and/or system embodiments may greatly increase the importance of fall detection devices, as it manages to provide privacy and convenience to prediction of fall to the user.

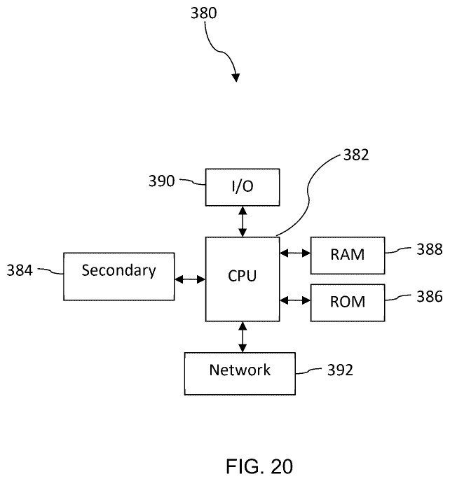

FIG. 20 illustrates a computer system 380 suitable for implementing one or more embodiments disclosed herein. For example, the edge device and/or one or more processors within any of the accessory monitoring device(s) can be implemented as a computer system as described herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

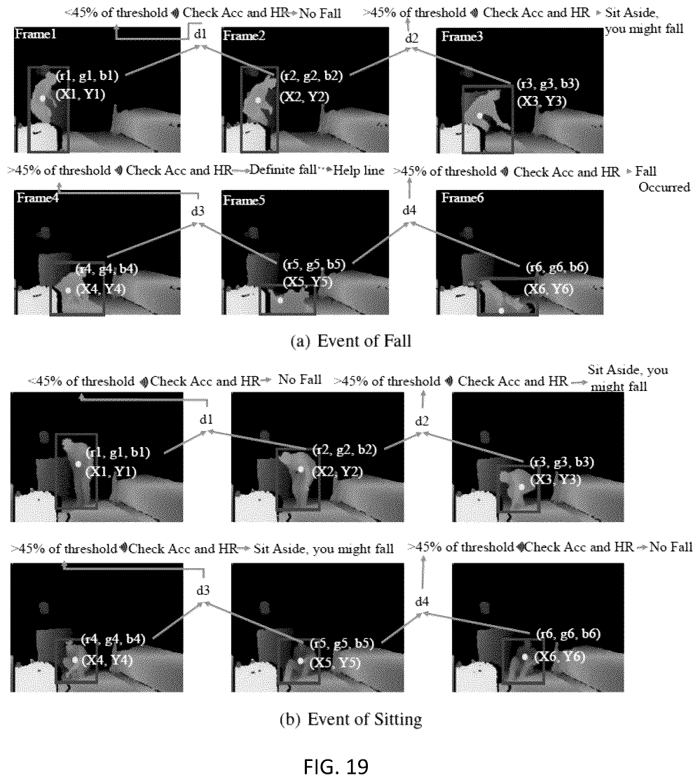

Disclosed systems may provide effective fall detection, for example using validations or training on labeled data sets. A labeled data set with 144 instances of data where 6 subjects had performed sitting and falling separately. The process of sitting and falling was captured by a depth camera in this dataset. When these instances were fed to an exemplary model of the disclosed system, the change in differentiating the sitting to falling was found with an approximate accuracy of 95%. The differentiation is represented starting from taking the x and y axes, as stated in Algorithm 1 for making decision of fall as stated in Table 2. The event of Falling Vs event of Sitting is represented in FIG. 19. The methodology implemented in the disclosed system has been effectively validated with state-of-the-art research and wearables.

Having described various systems and methods, certain aspects can include, but are not limited to:

In a first aspect, a system for detecting falls comprises: one or more physiological sensor configured to sense physiological data from a user; an accelerometer and/or gyroscope; one or more cameras; and a processor configured to receive data from the one or more physiological sensor, the accelerometer and/or gyroscope, and the one or more camera, analyze the data, and to determine a fall status of the user.

A second aspect can include the system of the first aspect, wherein the fall status comprises fallen and no-fall.

A third aspect can include the system of the second aspect, wherein responsive to determining the fall status as fallen, the processor is further configured to automatically transmitting an alarm signal (e.g. to doctors and/or family).

A fourth aspect can include the system of any one of the first to third aspects, wherein analyzing the data comprises comparing g's detected by the accelerometer and/or gyroscope to an acceleration threshold, and comparing the physiological data to a related physiological threshold.

A fifth aspect can include the system of any one of the first to fourth aspects, wherein the physiological data comprises heart rate of the user (e.g., for comparison to resting heart rate).

A sixth aspect can include the system of any one of the first to fifth aspects, further comprising using image data analysis for verification of fall status.

A seventh aspect can include the system of the first or second aspect, wherein analyzing the data comprises using image data analysis configured for fall detection (e.g., orientation change detected by camera, for example between frames), and comparing the physiological data to a related physiological threshold or comparing the g's to an acceleration threshold.

An eighth aspect can include the system of any one of the second to seventh aspects, wherein responsive to determining fall status as fallen, transmitting image data (e.g. capturing the environment of the user and sending it to doctors and/or family) from before, during, and/or after the fall (e.g. to allow human assessment and/or to provide visual information of the environment to assist in locating the user).

A ninth aspect can include the system of any one of the first to eighth aspects, wherein the one or more physiological sensor is configured to be worn by the user, and the accelerometer and/or gyroscope is configured to be worn by the user.

A tenth aspect can include the system of any one of the first to ninth aspects, wherein at least one of the one or more camera is configured to be worn by the user.

An eleventh aspect can include the system of any one of the first to tenth aspects, wherein at least one of the one or more camera is configured to be stationary/wall-mounted (e.g., disposed in a room).

A twelfth aspect can include the system of any one of the first to ninth aspects, wherein the one or more camera includes a first camera worn by the user and a second camera which is stationary/wall-mounted, and wherein the processor compares image data from the first and second camera.

A thirteenth aspect can include the system of any one of the first to twelfth aspects, wherein responsive to acceleration data indicating fallen status, the one or more camera is activated, the heart rate variability is checked, and/or visual image orientation data is checked.

A fourteenth aspect can include the system of any one of the first to thirteenth aspects, wherein user fall status further comprises fall possibility (e.g., sit aside, you might fall-due to potential fall conditions).

A fifteenth aspect can include the system of the fourteenth aspect, wherein responsive to determining that the user fall status is not fallen (e.g., based on the acceleration data and/or the image data) but that physiological data is indicative of fall possibility (e.g., potential fall conditions), signaling (e.g., at an output device on or in proximity to the user) user caution and/or providing recommendations to prevent falling (e.g., sit aside).

A sixteenth aspect can include the system of the fifteenth aspect, further comprising, responsive to determining that the user fall status is not fallen but that physiological data is indicative of fall possibility (e.g., potential fall conditions), automatically transmitting an alarm signal (e.g., to doctors and/or family).

A seventeenth aspect can include the system of any one of the third to sixteenth aspects, wherein the alarm signal includes image data (e.g., from the one or more camera).

An eighteenth aspect can include the system of any one of the third to seventeenth aspects, further comprising, responsive to alarm transmission and/or determination of fallen and/or fall possibility status, automatically providing communication connection between the user and the doctor and/or family (e.g., opening oral communication therebetween).

A nineteenth aspect can include the system of any one of the first to eighteenth aspects, wherein user fall status is discernable via an output device on the user (e.g., three different color lights, one indicative of fallen status, one indicative of no-fall status, and one indicative of fall possibility).

A twentieth aspect can include the system of any one of the first to nineteenth aspects, wherein the processor is further configured to analyze the data to determine a prediction of fall (e.g., based on physiological parameters such as heart rate changes).

In a twenty first aspect, a wearable fall detection device comprises: one or more physiological sensor configured to sense physiological data (e.g., such as heart rate and/or other parameter(s) indicative of stress) from the user; an accelerometer and/or gyroscope (e.g., configured to detect g's in at least the y-axis and provide related acceleration data); one or more camera (e.g., configured to provide visual data); and a processor configured to receive data from the one or more physiological sensor, the accelerometer and/or gyroscope, and the one or more camera, analyze the data, and determine user fall status.

A twenty second aspect can include the device of the twenty first aspect, wherein the device is configured to be mounted to a user's chest.

A twenty third aspect can include the device of the twenty first aspect, wherein at least the accelerometer/gyroscope and/or camera are configured to be mounted to the user's chest.

While embodiments have been shown and described, modifications thereof can be made by one skilled in the art without departing from the spirit and teachings of this disclosure. The embodiments described herein are exemplary only, and are not intended to be limiting. It should be understood that any exemplary information herein represents a non-limiting example. Many variations and modifications of the embodiments disclosed herein are possible and are within the scope of this disclosure. For example, the various elements or components may be combined or integrated in another system or certain features may be omitted or not implemented. Also, techniques, systems, subsystems, and methods described and illustrated in the various embodiments as discrete or separate may be combined or integrated with other techniques, systems, subsystems, or methods without departing from the scope of this disclosure. Other items shown or discussed as directly coupled or connected or communicating with each other may be indirectly coupled, connected, or communicated with. Method or process steps set forth may be performed in a different order. The use of terms, such as “first,” “second,” “third” or “fourth” to describe various processes or structures is only used as a shorthand reference to such steps/structures and does not necessarily imply that such steps/structures are performed/formed in that ordered sequence (unless such requirement is clearly stated explicitly in the specification).

Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R1, and an upper limit, Ru, is disclosed, any number falling within the range is specifically disclosed. In particular, the following numbers within the range are specifically disclosed: R=R1+k*(Ru−R1), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Language of degree used herein, such as “approximately,” “about,” “generally,” and “substantially,” represent a value, amount, or characteristic close to the stated value, amount, or characteristic that still performs a desired function or achieves a desired result. For example, the language of degree may mean a range of values as understood by a person of skill or, otherwise, an amount that is +/−10%.

Use of broader terms such as comprises, includes, having, etc., should be understood to provide support for narrower terms such as consisting of, consisting essentially of, comprised substantially of, etc. When a feature is described as “optional,” both embodiments with this feature and embodiments without this feature are disclosed. Similarly, the present disclosure contemplates embodiments where this “optional” feature is required and embodiments where this feature is specifically excluded.

It should be understood that relative terms such as “hot,” “cold,” “hotter,” “cooler,” “colder,” are relative terms and do not denote any specific number or range (but rather a relative value with respect to some other aspect). For example, reference to a hot fluid means that the fluid is hotter than a cool fluid of the system and/or has been heated, while reference to a cool fluid means a fluid that is cooler/colder than a hot fluid of the system and/or has not been heated or has been heated less than the fluid of another portion of the system (for example another portion of the system with which the fluid is interacting).

Accordingly, the scope of protection is not limited by the description set out above, but is intended to be inclusive. For example, any appendices hereto are fully incorporated herein. The claims which follow, illustrate the scope of some embodiments, and that scope including all equivalents of the subject matter of the claims. Each and every claim is incorporated into the specification as embodiments of the present disclosure. Thus, the claims are a further description and are an addition to the embodiments of the present disclosure. The discussion of a reference herein is not an admission that it is prior art, especially any reference that can have a publication date after the priority date of this application. The disclosures of all patents, patent applications, and publications cited herein are hereby incorporated by reference, to the extent that they provide exemplary, procedural, or other details supplementary to those set forth herein.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

As used herein, the term “and/or” includes any combination of the elements associated with the “and/or” term. Thus, the phrase “A, B, and/or C” includes any of A alone, B alone, C alone, A and B together, B and C together, A and C together, or A, B, and C together.

1. A system for detecting falls, comprising:
at least one accessory monitoring device comprising:
one or more physiological sensor configured to sense physiological data from a user;
an accelerometer and/or gyroscope;
one or more cameras; and
a processor configured to:
receive data from the one or more physiological sensor, the accelerometer and/or gyroscope, and the one or more camera,
analyze the data, and
determine a fall status of the user.

2. The system of claim 1, wherein the fall status comprises fallen and no-fall.

3. The system of claim 2, wherein responsive to determining the fall status as fallen, the processor is further configured to automatically transmitting an alarm signal.

4. The system of claim 2, wherein, responsive to a determination of the fall status as fallen, the processor is configured to transmit image data from before, during, and/or after the fall.

5. The system of claim 2, wherein user fall status further comprises fall predicted.

6. The system of claim 3, wherein the alarm signal includes image data.

7. The system of claim 3, further comprising, responsive to alarm transmission and/or determination of fallen and/or fall possibility status, automatically providing communication connection between the user and an emergency provider.

8. The system of claim 1, wherein analyzing the data comprises comparing g's detected by the accelerometer and/or gyroscope to an acceleration threshold, and comparing the physiological data to a related physiological threshold.

9. The system of claim 1, wherein the physiological data comprises heart rate of the user.

10. The system of claim 1, wherein the processor is further configured to use image data analysis for verification of fall status.

11. The system of claim 1, wherein the processor is configured to analyze the data by using image data analysis configured for fall detection, and compare the physiological data to a related physiological threshold or comparing the g's to an acceleration threshold.

12. The system of claim 1, wherein the at least one accessory monitoring device is configured to be worn by the user.

13. The system of claim 1, wherein at least one of the one or more camera is configured to be worn by the user.

14. The system of claim 1, wherein at least one of the one or more camera is configured to be stationary or wall-mounted.

15. The system of claim 1, wherein the one or more camera includes a first camera worn by the user and a second camera which is stationary or wall-mounted, and wherein the processor compares image data from the first and second camera.

16. The system of claim 1, wherein responsive to acceleration data indicating fallen status, the one or more camera is activated, the heart rate variability is checked, and/or visual image orientation data is checked.

17. The system of claim 1, wherein user fall status is discernable via an output device on the user.

18. A wearable fall detection device, comprising:
one or more physiological sensor configured to sense physiological data from a user;
an accelerometer and/or gyroscope;
one or more camera; and
a processor configured to receive data from the one or more physiological sensor, the accelerometer and/or gyroscope, and the one or more camera, analyze the data, and determine user fall status.

19. The device of claim 18, wherein the device is configured to be mounted to a user's chest.

20. The device of claim 18, wherein at least the accelerometer and/or gyroscope and/or the one or more camera are configured to be mounted in a personal care item for the user.
